(19) United States
(12) Patent Application Publication
(10) Pub. No.: US 2022/0395878 A1
(43) Pub. Date: Dec. 15, 2022

(54) WASTE DISPOSAL METHOD

(71) Applicant: ENRICHMENT TECHNOLOGY COMPANY LTD. ZWEIGNIEDERLASSUNG DEUTSCHLAND, Jülich (DE)

(72) Inventors: Jürgen AGREITER, Düren (DE); Stephan KRONHOLZ, Jülich (DE); Swen SIEGERT, Titz (DE)

(21) Appl. No.: 17/774,549

(22) PCT Filed: Oct. 30, 2020
(86) PCT No.: PCT/EP2020/080543

§ 371 Date: May 5, 2022

(30) Foreign Application Priority Data
Nov. 6, 2019 (EP) 19207346.8

(51) Int. Cl. B09B 3/45; B09B 3/70; B09B 3/38; G21F 9/32

(52) U.S. Cl. CPC B09B 3/45; B09B 3/70; B09B 3/38; G21F 9/32; B09B 2101/50

(57) ABSTRACT

The invention relates to a method for the disposal of a composite material, in particular a composite material contaminated, for example, by radioactivity and containing fluorine impurities. The inventive method for the disposal of a component containing a composite material with a composite matrix and a technical fiber, is characterized in that the component is chemically gasified, wherein the composite material is technically completely decomposed into its basic components, wherein in a first step the composite matrix is dissolved and in a subsequent step the remaining starting materials and intermediate products are thermally decomposed and reacted with added process gases, wherein at least in the subsequent step a reactive gas is supplied and the subsequent step is conducted endothermically.

The invention relates to a method for the disposal of a component containing a composite material, in particular a component containing, for example, a radioactively contaminated composite material, for example containing fluorine contaminations.

Modern materials, in particular modern high-performance materials, increasingly contain special materials that make disposal more difficult. A prominent example is the use of carbon fibers in composite materials, the carbon fiber reinforced plastics CFRP. Carbon fiber as a construction material is a highly resistant material, which means that components made of CFRP have very high strength values on the one hand and exceptionally low weight on the other. As a result, CFRP components are increasingly being used for structures subjected to high loads, where low weight of the structures is required or desirable. These can be, for example, components of an aircraft or a spacecraft or components under high dynamical stress in which moments of inertia are to be kept low. In particular, such components can also be components from centrifuges for uranium enrichment, where the disposal of such components is further complicated by the fact that the components may be radioactively contaminated. Heavy metals, in particular uranium, can burn into the carbon fiber, especially during the cleaning process, so that washing processes after efficient separation of fiber and matrix material of a fiber composite do not result in sufficient separation and heavy metals, in particular uranium, can still remain in the fiber even after several washing cycles.

From “Pyrohydrolysis, a clean separation method for separating non-metals directly from solid matrix, VG Mishra, S Jeykumar, Radioanalytical Chemistry Division, Bhabha Atomic Research Center, India (https://medcraveonline.com/OAJS/pyrohydrolysis-a-clean-separation-method-for-separating-non-metals-directly-from-solid-matrix.html)” hydropyrolysis is known, a process by which halogens in particular can be separated from solid matrices at temperatures between 900 and 1,200° C. in the presence of water. In this process, moderators, i.e. reaction accelerators or catalysts, can be added as additives that exhibit slow reaction kinetics. A disposal of a fiber-reinforced composite is not disclosed.

From the international patent application WO 2015/186 866 A1, a pyrolysis device is known that uses microwaves for heating. Inert gas is used in the processing of fiber-reinforced composite material with this device, so that the fiber is not destroyed and can be recycled.

From the Japanese patent JP 2 722 965 B2, as well as from the US patent U.S. Pat. No. 6,676,716 B2, the burning of fiber-reinforced composites and especially also of carbon fibers is known. The fiber-reinforced composite material to be disposed of is diluted with additional fuel, and the reaction proceeds exothermically. An explosive reaction process cannot be ruled out, making the process difficult to control. In addition, combustion can produce hazardous reaction products, for example, oxyfluorides, by burning fluorine compounds.

From Russian patent RU 2 239 899 C2, a method of treating radioactive graphite, and in particular radioactive graphite resulting from graphite used as a braking substance in a number of nuclear reactor designs, is known. First, radioactive graphite is reacted at a temperature above 350° C. to 700° C. with superheated steam or gases containing water vapor to form hydrogen and carbon monoxide. Water and carbon dioxide are then formed from the hydrogen and carbon monoxide from the first step. This process can also produce dangerous reaction products, such as oxyfluorides, from burning fluorine compounds. In addition, uncontrolled release of uranium compounds may occur.

Thus, all known methods for combustion of fiber-reinforced composites involve high temperatures and further fuel and/or oxygen. In the case of a fiber composite with carbon fibers, for example, this is due to the production of the carbon fiber, in which the carbon fiber base material is carbonized above 2000° C. and graphitized to a greater or lesser extent, depending on the type of fiber. The resulting, technical product of carbon fiber is highly pure, virtually free of impurities and more resistant than graphite. If a CFRP component is contaminated with fluorine and/or uranium, for example, conventional combustion would result in an uncontrolled release of fluorine and/or uranium compounds and/or would give rise to safety-relevant hazardous substances that are, for example, explosive and/or toxic.

The task of the invention is to specify a method by means of which it is possible to dispose of a component made of a fiber-reinforced composite material, for example CFRP, and in particular a radioactively contaminated component, which may contain in particular halogen impurities, made of a composite material, in a manner which complies with the law and is as environmentally friendly as possible, the aim being to exclude the possibility of environmentally harmful, in particular radioactive, substances resulting also from impurities in the fiber being released into the environment.

According to the invention, this task is solved by a method having the features of independent claim 1. Advantageous further embodiments of the method result from dependent claims 2 to 18.

The inventive method for the disposal of a component containing a composite material with a composite material matrix and a technical fiber, is characterized in that the component is chemically gasified, the composite material being technically entirely decomposed into its basic constituents, the composite material matrix being dissolved in a first step and the remaining starting materials and intermediate products being thermally decomposed in a subsequent step and reacted with added process gases, a reactive gas being supplied at least in the subsequent step and the subsequent step being conducted endothermically.

Some terminology will be explained in the following:

Here and in the following, a component is understood to mean a single part of a technical complex. The technical complex may have several components. The technical complex can be, for example, a plant for uranium enrichment, where a component can be, for example, a centrifuge body. In this case, the component may comprise, among other things, a composite material, in particular a fiber composite with a technical fiber embedded in a matrix material. A technical fiber is understood here to mean a fiber with a technical function, in particular a man-made fiber, i.e. a fiber whose composition and structure can be influenced by man. In particular, high-strength fibers can be produced. The best-known high-strength technical fibers are glass fibers, carbon fibers or aramid fibers. In fiber-reinforced composites, the technical fibers have the function of increasing the strength of the component made from the composite. For example, the composite material may be a carbon fiber reinforced plastic, also known as CFRP. CFRP consists of carbon fibers embedded in a matrix of synthetic resin. Here, the mechanical properties of the cured composite benefit primarily from the tensile strength and stiffness of the carbon fibers. The matrix prevents the fibers from being displaced with respect to each other under load. The strength and stiffness of a material made from CFRP are much higher in the fiber direction than across the fiber direction. For this reason, individual fiber layers can be laid in different directions. The fiber directions are determined by the designer to achieve a desired strength and stiffness. Compared to materials such as steel, carbon fibers have a significantly lower density (˜factor 4.3). Their weight-specific stiffness in the fiber direction is, depending on the fiber type, slightly (˜10-15%) or even significantly (about factor 2) higher than steel. This results in a very stiff material that is particularly suitable for applications with a main load direction, where low mass combined with high stiffness is important. The use of CFRP is also particularly advantageous for components subjected to high dynamic loads, as dynamic forces are lower due to the lower mass of CFRP components compared with corresponding steel components, for example.

In this paper, disposal is used as a generic term for all processes and activities that serve to dispose of or recycle waste. Disposal thus serves the purpose of waste removal, i.e. the release of waste into the environment in compliance with prescribed limit values or the transfer to a final repository. In particular, the disposal of radioactive solid waste is a largely unsolved problem, and such waste can now only be stored in suitable final disposal sites after prior conditioning and packaging. Such suitable disposal sites are rare. The storage capacity of known final disposal sites for radioactive solid waste is very limited and, in particular, less than the demand.

Gasification is the conversion of a solid or liquid into a gas. In contrast to vaporization, chemical gasification involves the splitting and rearrangement of existing chemical compounds by cracking or pyrolysis and/or reduction or partial oxidation and/or hydrogen transfer. This process occurs at high temperatures, with a limited amount of oxygen.

In this paper, a basic constituent is understood to be a decomposition product of the composite. Decomposition involves breaking down a chemical compound of the composite into smaller molecules or even chemical elements. The decomposition of a chemical substance occurs, for example, by supplying energy in the form of heat. The energy supplied causes bonds within molecules to break up. This often produces radicals, which then continue to react as unstable, high-energy particles. In the absence of oxidizing agents such as atmospheric oxygen, this decomposition can occur down to the elements of which the compound is composed or to compounds that are thermodynamically most stable under the selected conditions. If oxidizing agents are present during decomposition, the most stable compounds are formed from combustible materials under combustion with the oxidizing agent, sometimes without the addition of energy. If the oxidizing agent is oxygen (for example from the air), water H₂O and carbon dioxide CO₂ (possibly also sulfur oxides, nitrogen oxides or nitrogen as a gas) are formed from organic compounds, and oxides or other oxygen-containing compounds such as sulfates, phosphates or silicates are usually formed from inorganic substances.

A “technically complete” decomposition of a composite material into its basic constituents does not mean 100% decomposition of the composite material into its basic constituents. Rather, in the case of technically complete decomposition, larger molecules than those corresponding to the basic constituents may remain at the end of the process. In addition, the composite material may contain traces of non-gasifiable substances, for example metals and/or semimetals or their compounds, as impurities or additives, which produce small amounts of mostly oxidic residues. However, even substances that are difficult to gasify are also essentially gasified, especially the carbon fiber. The carbon fiber is explicitly not recovered.

In a preferred embodiment, the reactive gas for processing a fiber-reinforced composite comprising a carbon fiber includes an oxidizing agent. An oxidizing agent is a substance that can oxidize other substances and is itself reduced in the process. Oxidizing agents can accept electrons. The oxidizing agent may contain oxygen. For example, the oxidizing agent may be a compound that readily releases oxygen, such as hydrogen peroxide, permanganate or dichromate, or may be pure oxygen.

In an advantageous embodiment, the oxidizing agent is metered such that the process occurs under controllable conditions, avoiding the formation of reaction products that are hazardous to the environment and/or people's health. Here, the supply of the oxidizing agent can be controlled or regulated. The process temperature, for example, can be used as the controlled variable. However, also the volume flow rate can be used to control or regulate the feed flow of the oxidant. Both variables can be easily measured and can be easily influenced by varying the amount of oxidant fed per unit time. In this process, an uncontrolled supply of oxidant can lead to an explosive, exothermic reaction, which can be effectively prevented by a controlled or regulated oxidant supply. This safety measure is of particular importance in the field of nuclear waste disposal. It has been found to be advantageous if the maximum oxygen content is 8% in the reaction atmosphere.

Alternatively, the technical fiber can be an aramid fiber. In a further advantageous embodiment, the moderator is also metered in such a way that the process occurs under controllable conditions.

In an alternative embodiment, the technical fiber is a glass fiber, with the reactive gas containing fluorine.

It has been found to be advantageous if the method first comprises hydropyrolysis. Hydropyrolysis has the advantage of not generating secondary waste, being able to expel halogens such as fluorine in gaseous form, and being able to separate the elements of the CFRP from the semimetal and/or metal impurities such as uranium. The steam from the hydropyrolysis process converts the halogens on and in the surface of the fiber composite into gaseous hydrogen halides that can be expelled at sufficiently high temperatures. The halogens can then be isolated in a further, subsequent process step. In an advantageous embodiment, the gaseous hydrogen halides are isolated by neutralization in an alkaline wash solution. Alternatively, the hydrogen halides can also be isolated by condensation.

Furthermore, it has been found advantageous if the subsequent step is carried out at a temperature of more than 800° C., preferably at more than 1,200° C., particularly preferably at more than 1,350° C.

Furthermore, it has been shown to be advantageous if the subsequent step is carried out at a temperature of at most 1,600° C., preferably at the most 1,500° C.

Furthermore, it has been shown to be advantageous if a moderator is added to the process for energy regulation.

In an advantageous embodiment, the moderator contains water, where the water can be introduced into the process via a residual moisture content of the material of the component.

Similarly, the moderator may be supplied to the process in gaseous form, wherein the moderator contains water vapor, ammonia, and/or carbon dioxide. It has further been shown to be advantageous if the moderator is present in excess, in particular in excess of 20%, in the reaction atmosphere. It has been found to be particularly advantageous if the moderator is present in excess of 50% in the reaction atmosphere.

In a further advantageous embodiment of the method, any condensable substances of the component which have been at most partially converted are post-combusted. Stable, gasifiable impurities or intermediate products such as carbon monoxide CO or dioxins, for example, are further separated or rendered inert by the afterburning of the pyrolysis gases at high temperatures and excess oxygen.

The gasification process of the component made of a fiber-reinforced composite material, in particular a carbon fiber-reinforced composite material, including the carbon fiber, is based on the principle of hydropyrolysis, so that at the beginning of the process the composite matrix is dissolved, volatile impurities are vaporized and impurities with affinity to hydrogen, such as halides as hydrogen halide, can be expelled. In a subsequent endothermic step, remaining starting materials and intermediates are thermally decomposed and reacted with the added process gases. Moderating media such as H₂O, NH₃, CO₂ etc. can be used as process gases and O₂, H₂, F₂ etc. as reactive media. In particular, the admixture of small amounts of O₂ of less than 8% in the reaction atmosphere promote the gasification of the fibers without inducing the hazard potential of a self-sustaining reaction. With the introduction of mechanical energy, for example kinetic energy, into the mass to be processed, the most efficient gasification can be achieved, in particular by generating an activation of the surface, so that rotary kilns or paddle kilns are preferable, for example. In terms of process technology, the combination of hydropyrolysis with the low addition of oxygen (up to 8%) at elevated temperatures (800-1500° C.) goes beyond the reaction window of conventional graphite hydropyrolysis, as the carbon fiber is more resistant. At the same time, the inventive process does not pose the safety risks of conventional combustion because, for example, hazardous reaction products, such as oxyfluorides, are suppressed and a self-sustaining reaction is avoided.

By gasifying all further fiber composite components, excluding non-gasifiable trace impurities, following the first process step of hydropyrolysis, the elements of the composite are separated from heavy metals such as uranium, since only metals and/or semimetals are retained as solids in the form of slag. By gasifying all gasifiable components including the carbon fiber, components or fiber-reinforced composites to be processed can be decomposed into their elements and isolated and reused, for example, as a pure substances or base chemicals. For example, N₂, H₂, H₂O, CO, CO₂, HF or HCl can be produced.

In any case, the energy can be supplied, for example, in the form of heat and/or mechanical energy, for example, in a furnace.

All gasifiable constituents of the composite can be processed stepwise, allowing separation into the basic constituents to the largest extent possible. The energy input can also be increased in steps, so that the components with the lowest energy requirement for gasification are gasified first and, after increasing the energy input by one step, the components with the correspondingly higher energy requirement are gasified. The various components can be tapped individually. This procedure corresponds to what is called batch operation: the material is placed in a furnace, the complete process is run with all heating stages in succession, and the respective gas composition is tapped at each step. The step size can be selected according to the composite material to be gasified. The energy input can be increased until all gasifiable components of the composite material have been decomposed and converted into the gaseous aggregate state.

Alternatively, the process can also be started with a maximum energy supply corresponding to the composite material to be processed. In this case, all gasifiable components are converted to the gaseous state as far as possible at the same time. The various gases can then be separated by means of further special separation processes known to the person skilled in the art, such as acid washing, distillation, etc. Continuous operation is possible with this process.

In a further embodiment of the method, condensable substances of the component which have been at most partially converted are post-combusted. In this paper, the term “substances” refers to process products formed from the processed material. These substances may be gaseous, liquid or solid. The substances may be reusable or not useful for further use. Post-combustion is known to the person skilled in the art, so that he can select suitable methods and method parameters.

Mineral compounds from the possibly contaminated composite material, in particular semi-metals, metals and metal compounds such as, for instance, uranium compounds, remain in the slag as solids and can be easily separated as solids.

The active principle of separation is a combination of pyrolysis, hydrolysis and partial oxidation. With pyrolysis, primarily resin compounds are processed or cracked and with partial oxidation primarily carbon-carbon bonds are separated. Fluorine compounds are essentially hydrolyzed and uranium compounds are hydrolyzed in the case of uranium fluorides and uranyl. Other uranium compounds remain unchanged or are slightly reduced. Resin compounds are also partially hydrolyzed. By combining these active principles, the method according to the invention makes it possible to separate all components as far as possible, including possibly contaminated composite components. By selecting the reaction conditions, in particular the temperature range and/or the supply of moderators and oxidizing agents, the partial reactions act in a target-oriented sequence; in particular the hydrolysis proceeds in a before the oxidation in terms of reaction mechanisms. With the method according to the invention, the legally compliant and environmentally compatible material separation in particular of contaminated waste is possible. Especially in the case of radioactively contaminated waste, decontamination is required, which is made possible by breaking down the materials of the contaminated component into its basic constituents. Any parts of the component or materials that cannot be decontaminated still have to be disposed of. However, since these are minimized by the process and, in particular, also have significantly less volume than the original component, the capacities of the available final storage facilities are significantly less burdened. If the process results in complete material separation, it is even possible to recover contaminating materials, impurities and/or substances, in particular also uranium or uranium compounds, and to completely avoid the final disposal of such materials.

If F₂ is used as the reactive gas, glass fiber-reinforced composites can also be gasified using an otherwise identical method.

By controlling the process speed and material throughput, the method according to the invention can achieve complete conversion of all gasifiable materials of the component. Here, the term “regulate” is also understood to mean “control”. In other words, regulating is understood here to mean the directed influencing of the behavior of the process with or without feedback. The term “complete implementation” shall be subject to a technical understanding. In other words, “complete” does not have to mean absolute completeness; even nearly complete conversion with technically negligible, unconverted residual amounts of materials shall fall under the term “complete conversion”. The degree of conversion can be influenced within wide limits by the process variables energy input and mass throughput of moderators and oxidizing agents and the material to be converted. The term “energy input” covers the input of both thermal and mechanical energy.

Further advantages, particularities and expedient further embodiments of the invention result from the dependent claims and the following illustration of a preferred example of embodiment on the basis of the FIGURE.

In the Figures:

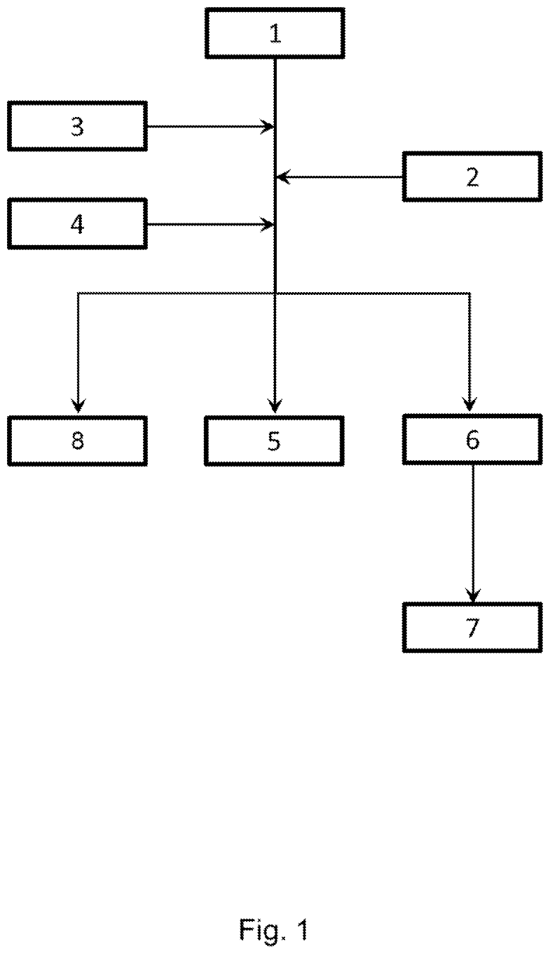

FIG. 1 shows an example of embodiment of a process flow for the disposal of a component made of a composite material.

FIG. 1 shows an example of embodiment of a process flow for the disposal of a component made of a composite material. First, with reference numeral 1, the component made of a composite material is fed to the process. The component may be, for example, a centrifuge body of a uranium enrichment plant. The component may comprise a composite material, in particular a fiber composite with a fiber embedded in a matrix material. For example, the composite material may be a carbon fiber reinforced plastic, also called CFRP, or a composite material comprising aramid fiber. Energy is supplied to the process with reference number 2, a moderator is supplied with reference number 3, and an oxidizing agent is supplied with reference number 4. The component can be fed into a furnace, for example a rotary kiln or paddle kiln or a fluidized bed reactor. On the one hand, energy is supplied in the form of thermal energy by heating the furnace to at least 800° C. On the other hand, energy is supplied to the process in the form of mechanical energy. In this context, the supply of mechanical energy primarily serves to create new surfaces and/or to achieve a stoking effect and thus to create better attacking possibilities for an oxidizing agent. The supply of the mechanical energy can occur, for example, via a rotary motion, for example by stirring, and/or via a swirling of the component and/or parts of the component. The moderator is supplied for energetic process regulation. The moderator can be introduced into the process in the form of water as residual moisture of the material of the component. However, the moderator can also be supplied to the process alternatively or additionally in gaseous form, and in particular can also be metered in in a regulated or controlled manner, where the moderator can contain water vapor, ammonia and/or carbon dioxide. Endothermic process control can be enforced by the defined supply of the moderator as a function of the composite material to be gasified and/or the process temperature and/or the process speed. Due to the endothermic process control, the process can be controlled at any time. Further, at reference number 4, an oxidant is added to the process. The oxidant may comprise oxygen. For example, the oxidant may be a compound that readily releases oxygen, such as hydrogen peroxide, permanganate or dichromate, or may be pure oxygen. The supply of the oxidant may be controlled or regulated. As a controlled variable, the process temperature, for example, can be used. But also the volume flow rate can be used to control or regulate the feed flow of the oxidant. Both variables can be easily measured and can be easily influenced by varying the amount of oxidant fed per unit time. Process speed and material throughput are controlled or regulated in such a way that complete conversion of all gasifiable materials of the component takes place. The degree of conversion can be influenced within wide limits by the process variables energy input and mass throughput of oxidant and material to be converted.

The basic constituents of the composite material, indicated by reference number 5, are the disposal product. Reference number 6 indicates any condensable substances of the component that have been at most partially reacted. These can be post-combusted at reference number 7. Reference numeral 8 indicates possible non-gasifiable substances of the component, as well as in particular the non-gasifiable impurities such as, for example, uranium compounds.

The FIGURE is not to be understood as meaning that the process steps must be carried out in a specific sequence. Rather, it is also possible, for example, that energy is supplied again after step 4, i.e. after the supply of an oxidizing agent. Energy in the form of thermal and/or mechanical energy can also be supplied throughout the entire process. Similarly, in batch operation, condensable substances (step 6) can also be formed even before the oxidant is added in step 4.

The embodiments shown herein represents only one example of the present invention and therefore should not be construed as limiting. Alternative embodiments contemplated by the person skilled in the art are equally encompassed by the scope of protection of the present invention.

### LIST OF REFERENCE NUMBERS

1 Feeding a component made of a composite material
2 Energy supply
3 Moderator supply
4 Oxidizing agent supply
5 Basic components of the composite material
6 Partially converted condensable substances
7 Post-combustion
8 Non-gasifiable substances

1. Method of disposing of a component containing a composite material, the composite material comprising a composite matrix and an engineered fiber, wherein the component is chemically gasified, the composite material being completely broken down technically into its basic constituents, the composite matrix being dissolved in a first step and, in a subsequent step, the remaining starting materials and intermediate products being broken down thermally and reacted with added process gases, a reactive gas being supplied at least in the subsequent step and the subsequent step being conducted endothermically.

2. Method according to claim 1, wherein the technical fiber is a carbon fiber and the reactive gas contains oxygen.

3. Method according to claim 2, wherein the oxygen supplied amounts to a maximum of 8% of the reaction atmosphere.

4. Method according to claim 1, wherein the technical fiber is a glass fiber and the reactive gas contains fluorine.

5. Method according to claim 1, wherein the first step comprises hydropyrolysis.

6. Method according to claim 5, wherein gaseous hydrogen halides are present as a result from hydropyrolysis, which are subsequently isolated.

7. Method according to claim 6, wherein the gaseous hydrogen halides are isolated by neutralization in an alkaline washing solution.

8. Method according to claim 1, wherein the subsequent step is carried out at a temperature of more than 800° C., preferably at more than 1,200° C., particularly preferably at more than 1,350° C.

9. Method according to claim 1, wherein the subsequent step is carried out at a temperature of at most 1,600° C., preferably at most 1,500° C.

10. Method according to claim 1, wherein the process is started with a maximum energy input corresponding to the composite material to be processed, so that all the constituents of the composite material are chemically gasified substantially simultaneously.

11. Method according to claim 1, wherein the chemical gasification is carried out under the action of mechanical energy.

12. Method according to claim 11, wherein the mechanical energy is introduced via a rotary motion.

13. Method according to claim 11, wherein the mechanical energy is introduced via a swirling of the component and/or parts of the component.

14. Method according to claim 1, wherein a moderator is supplied to the process for energy regulation.

15. Method according to claim 14, wherein the moderator contains water, the water being introduced into the process via a residual moisture content of the material of the component.

16. Method according to claim 14, wherein the moderator is fed to the process in gaseous form, the moderator containing water vapor, ammonia and/or carbon dioxide.

17. Method according to claim 1, wherein metal compounds and/or semi-metal compounds, in particular uranium compounds, remain as solids in the slag.

18. Method according to claim 1, wherein any condensable substances of the component which may be present and have been at most partially converted are post-combusted.
